(19) United States
(12) Patent Application Publication
(10) Pub. No.: US 2019/0174719 A1
(43) Pub. Date: Jun. 13, 2019

(54) Virtual Environment For Animal Training And Rehabilitation

(71) Applicant: Dan Perata, San Francisco, CA (US)

(72) Inventor: Dan Perata, San Francisco, CA (US)

(21) Appl. No.: 16/137,132

(22) Filed: Sep. 20, 2018

Related U.S. Application Data
(60) Provisional application No. 62/597,266, filed on Dec. 11, 2017.

(51) Int. Cl. A01K 15/02; G06F 3/14

(52) U.S. Cl. CPC A01K 15/021; G06F 3/1446; A01K 15/027

(57) ABSTRACT

An open or enclosed training and rehabilitation environment of a treadmill and stimuli introducing devices or the introduction of stimuli while the dog is attending to walking/running on the treadmill. A method of introducing a dog to a treadmill or other attention getting activity (e.g., having the dog walk or run on the treadmill), and introducing stimuli such as sounds, people, other animals/dogs, bangs, claps, etc., the introduced stimuli preferably being the same or similar to the kind of stimuli which the dog is known to react negatively when in the real world.

### CROSS REFERENCE TO RELATED APPLICATIONS

This application claims the benefit of priority to U.S. Provisional Patent Application Ser. No. 62/597,266, entitled “Virtual Environment For Animal Training,” Atty Ref 128034-8001.US00, filed Dec. 11, 2017, which is hereby incorporated by reference in its entirety.

COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

### Field of Invention

The present invention relates to various of the disclosed embodiments concerning a virtual environment for animal training.

### Discussion of Background

An example of animal training is that of dog training. Dog training is the application of behavior analysis which uses the environmental events of antecedents and consequences to modify the behavior of a dog, either for it to assist in specific activities or undertake particular tasks, or for it to participate effectively in contemporary domestic life. While training dogs for specific roles dates back to Roman times at least, the training of dogs to be compatible household pets developed with suburbanization in the 1950s.

A dog learns from interactions it has with its environment. This can be through classical conditioning, where it forms an association between two stimuli; non-associative learning, where its behavior is modified through habituation or sensitization; and operant conditioning, where it forms an association between an antecedent and its consequence.

Dog training teaches a response to cues or commands, or the performance of actions that is not necessarily natural to the dog, and also involves raising a dog to be accommodated to his environment by modifying natural digging, barking, and eliminating behaviors. Dog training is defined as the purposeful changing of a dog's behavior.

Dog training can be socialization to the domestic environment, basic obedience training, or training for specialized activities including law enforcement, search and rescue, hunting, working with livestock, assistance to people with disabilities, entertainment, dog sports, detection, and protecting people or property.

### SUMMARY OF THE INVENTION

The present inventors have realized a new method for socializing, acclimating, and general training of animals, particularly dogs. In one embodiment, the present invention provides a training system, comprising a treadmill and a stimuli introduction device. The stimuli introduction device may be a sound system or a live event operated/performed by a trainer such as a cymbal clash, shout, or sudden clap. The treadmill may comprise a wall-to-wall or essentially wall-to-wall track (e.g., wall-to-wall except for a narrow runway on one or both sides of the treadmill). The training system may be installed in a portable room, such as a shipping container or room of similar dimensions.

The present invention may be embodied as an open or enclosed training environment of a treadmill and any number of stimuli introducing devices. The present invention includes a method of introducing a dog to a treadmill or other attention getting activity (e.g., having the dog walk or run on the treadmill), and introducing stimuli such as sounds, people, other animals/dogs, bangs, claps, etc., the introduced stimuli preferably being the same or similar to the kind of stimuli which the dog is known to react negatively when in the real world. In one embodiment, the invention may be described as placing a dog on a treadmill while training the dog for something other than being on a treadmill.

Portions of both the device and method may be conveniently implemented in programming on a general purpose computer, or networked computers, and the results (e.g., video of a training session) may be displayed on an output device connected to any of the general purpose, networked computers, or transmitted to a remote device for output or display (e.g., streaming a session to an animal owner at a remote location). In addition, any components of the present invention represented in a computer program, data sequences, and/or control signals may be embodied as an electronic signal broadcast (or transmitted) at any frequency in any medium including, but not limited to, wireless broadcasts, cellular, and transmissions over copper wire(s), fiber optic cable(s), and co-ax cable(s), etc.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings. One or more embodiments of the present disclosure are illustrated by way of example and not limitation in the figures of the accompanying drawings, in which like references indicate similar elements, and wherein:

FIG. 1 is a perspective view of an animal training environment according to the invention;

FIG. 2 is a further perspective view of an animal training environment according to the invention;

FIG. 3 is a further perspective view of an animal training environment according to the invention;

FIG. 4 is a side view of an animal training environment according to the invention;

FIG. 5 shows a diagrammatic representation of a machine in the example form of a computer system within which a set of instructions for causing the machine to perform one or more of the methodologies discussed herein may be executed;

FIG. 6 is a flow chart of a training/habituation process/session according to an embodiment of the present invention;

FIG. 7 is a sketch of a training box according to various embodiments of the present invention; and

FIG. 8 is a sketch of an embodiment of the present invention illustrating a training environment with simulator like all-sides video.

Those skilled in the art will appreciate that the logic and process steps illustrated in the various flow diagrams discussed below may be altered in a variety of ways. For example, the order of the logic may be rearranged, sub-steps may be performed in parallel, illustrated logic may be omitted, other logic may be included, etc. One will recognize that certain steps may be consolidated into a single step and that actions represented by a single step may be alternatively represented as a collection of sub-steps. The FIGS. are designed to make the disclosed concepts more comprehensible to a human reader. Those skilled in the art will appreciate that actual data structures used to store this information may differ from the FIGS. and/or tables shown, in that they, for example, may be organized in a different manner; may contain more or less information than shown; may be compressed, scrambled and/or encrypted; etc.

### DESCRIPTION OF THE PREFERRED EMBODIMENTS

Various example embodiments will now be described. The following description provides certain specific details for a thorough understanding and enabling description of these examples. One skilled in the relevant technology will understand, however, that some of the disclosed embodiments may be practiced without many of these details.

Likewise, one skilled in the relevant technology will also understand that some of the embodiments may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this Detailed Description section.

A Virtual Environment for Animal Training, for which embodiments of the invention concern animal training and, more particularly, dog training. In embodiments of the invention, when a canine is in motion, we can introduce stimuli that would normally get an adverse reaction when a dog is still, and thus lessen or alleviate the stimuli's reaction. Embodiments of the invention accomplish this in a controlled manner with slow to moderate tread mill speed while the canine is shown visual and auditory representations of the stimuli that would cause the adverse reaction. In this control environment, some of the issues we can fix are as follows:
Recall
Human aggression
Fear aggression
Skateboard aggression
Scooter/Motorcycle aggression
Ball/toy aggression
Bike Reactivity
Skateboard Reactivity
Aggression/reactivity towards runners
Aggression/reactivity towards children
Fear of fireworks
Prey drive (cats, squirrels, birds, small dogs)
Anxiety/fearful out on walks (city sounds, large crowds)
Aggression towards shopping carts
Aggression towards strange/large figures approaching (ex. dogs who don't like men)
Dog aggression
Leash aggression
Fearful/hyper-vigilant at night
Chasing cars
Fearful of loud noises (construction, gunshots)
Fearful of trucks/buses/big rigs

Additionally, embodiments of the invention create a fully immersive environment that consists of a treadmill that has more options for speed and gradient movement, a complete surround video system (walls, ceiling, floors, etc.), which may include holograms or Pepper's ghost instantiations, a completely immersive surround sound, and additional environmental options that include temperature settings (warm to cold), scents, air and/or water jets, and sunlamps. This application could be used for both canines and humans.

At the same time, more and more advanced training programs could be offered to handle not just canine training options, but also rehabilitation and exercise programs.

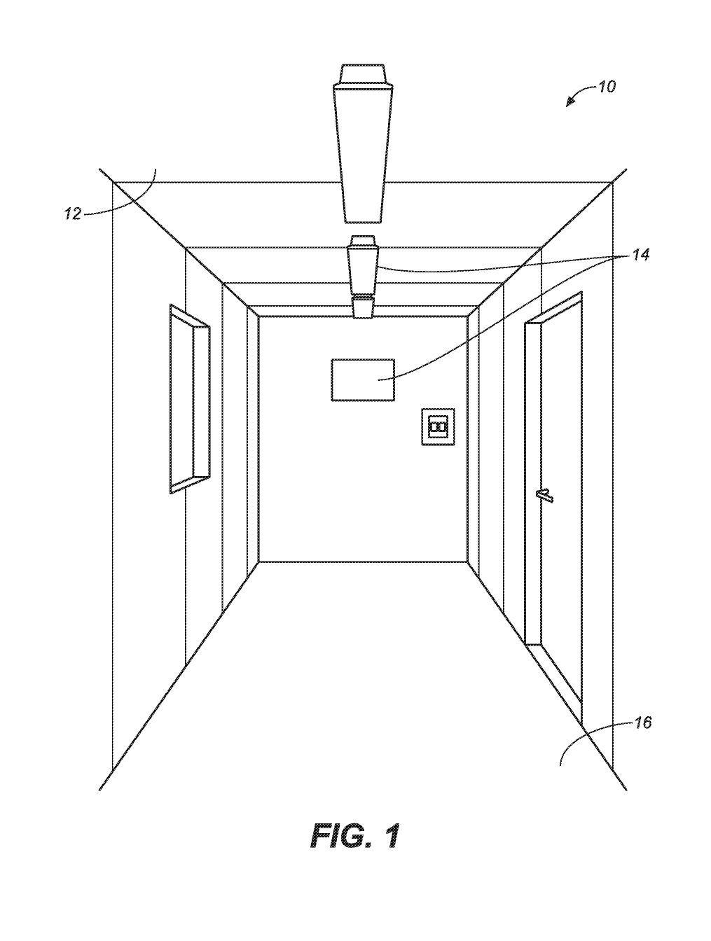

Referring again to the drawings, wherein like reference numerals designate identical or corresponding parts, and more particularly to FIG. 1 thereof, there is illustrated a perspective view of an animal training environment 10 according to the invention. In FIG. 1, an enclosure 12 contains a treadmill 16 and various environmental and virtual features 14.

The treadmill may be of any width, however, the present invention is best applied with a treadmill exceeding ordinary treadmill widths. The treadmill may be capable of hosting dog, owner, and trainer side-by-side. The present inventors currently have had great success with a treadmill reaching the width of a shipping container. The extended width allows the dog to get used to the treadmill very quickly, they provide space for reactions and other maneuvers important for various training regimes. Fort similar reasons, the length of the treadmill is preferably beyond typical treadmill dimensions, and the present invention includes embodiments where the treadmill length is equivalent to available space in a shipping container. Such dimensions may be extended or reduced to fit other enclosures.

Such environmental and virtual features can include, but are not limited to, lights, displays, speakers and other sound producing devices, fans, heaters and coolers, scent dispensers, tactile elements, cameras, microphones, temperature sensors, pressure sensors (for example, built into the matt of the treadmill to sense motion intensity), heart rate, blood pressure, respiration, and other sensors, and the like. Further, the treadmill may include a variable speed and gradient feature that increase and decreases the speed and/or gradient of the treadmill in any of a programmatic and random fashion, and that is operable to alter speed and/or gradient and/or stop the treadmill as desired in coordination with operation of the various environmental and virtual features. For example, a display may present the image of a child in need of rescue and the treadmill might slow down, where the dog would be cued to walk faster to reach the child.

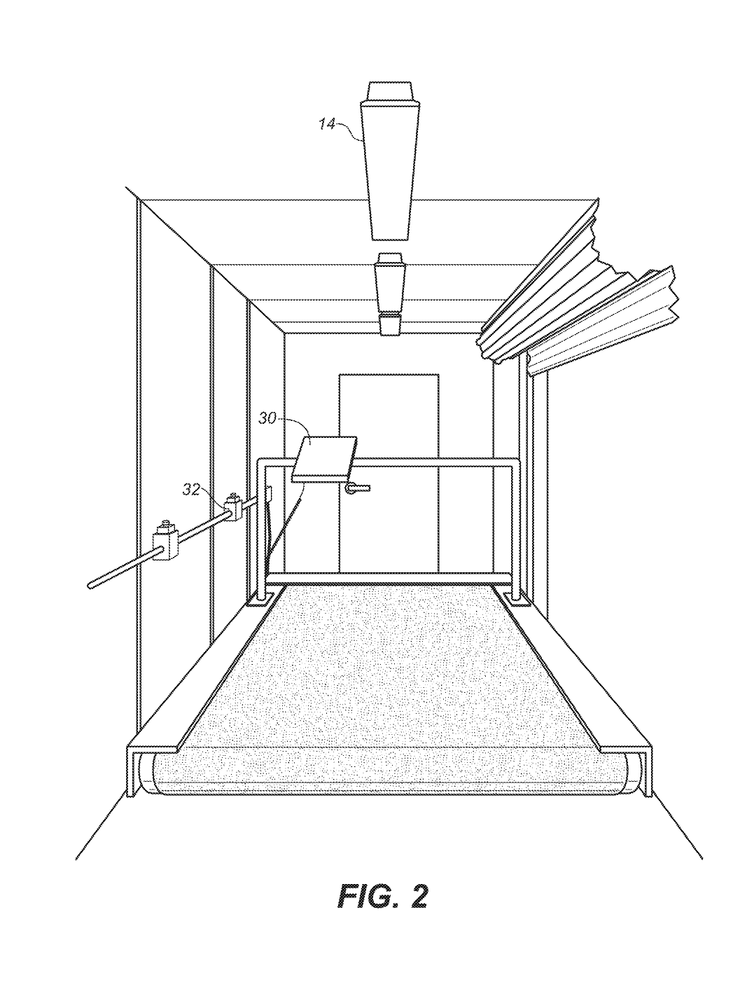

FIG. 2 is a further perspective view of a module comprising a configuration of an animal training environment according to the invention. In the illustrated configuration, a door is placed on the front wall ahead of the treadmill. The treadmill includes relatively narrow side paths on each side of the treadmill sufficient for trainer entry during treadmill operation or for trainer to exit the treadmill during a training session and remain in the module. Many alternative configurations may be utilized including a wider module with a yet wider treadmill that may be sufficient for additional side-by-side participants (e.g., 2 trainers plus a dog, 2 dogs plus a trainer, etc.). A wider module might also accommodate a same size treadmill with paths on one or each side of the treadmill. The length of the treadmill may also vary, with longer widths used generally for formation and/or team training, to introduce other stimuli behind and on the treadmill, etc.

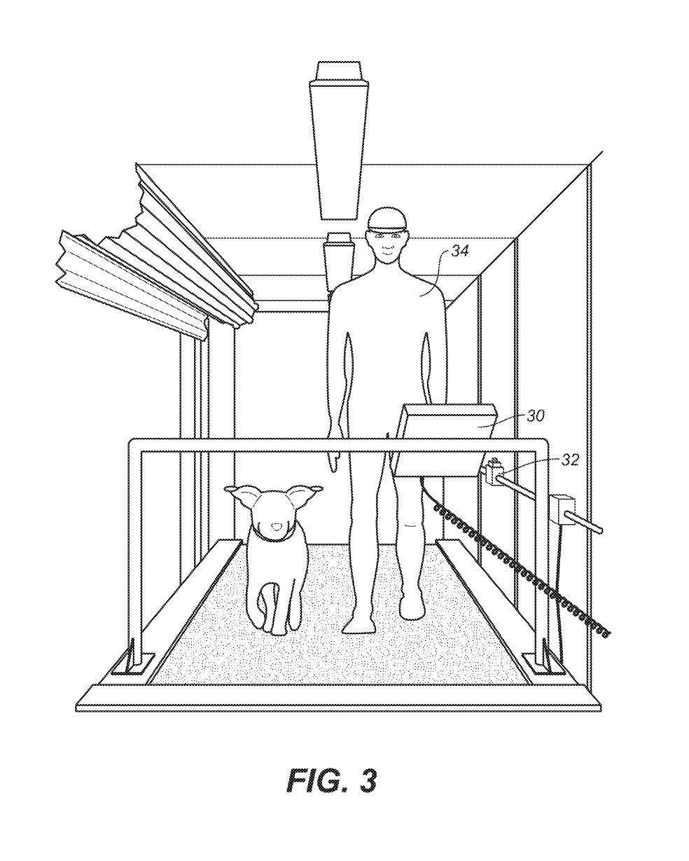

FIG. 3 is a further perspective view of an animal training environment according to the invention. In FIG. 3, a trainer 34 is shown. The environment includes an operating panel 30 and various safety switches 32 (stop operation switches). FIG. 3 also illustrates the dimensions of the treadmill and its installation in a portable shipping container (e.g., standard shipping container 20 ft or 40 ft, but may also utilize pod style containers, and custom boxes). As shown the dimension easily accommodate a trainer/owner and a reasonably sized dog with a fair amount of “elbow” room to allow side-to-side and front-to-back movement, provide space for the introduction of other stimuli, etc. The rollup door may be replaced with a window, standard hinged door, etc., and such doors windows may be utilized for lighting, observation, and/or introduction of stimuli and/or other effects. A trap door may be installed in the floor in front of the treadmill, at one or more sides, and/or rear of the treadmill, and/or as part of one or more screens installed to facilitate video in the training environment.

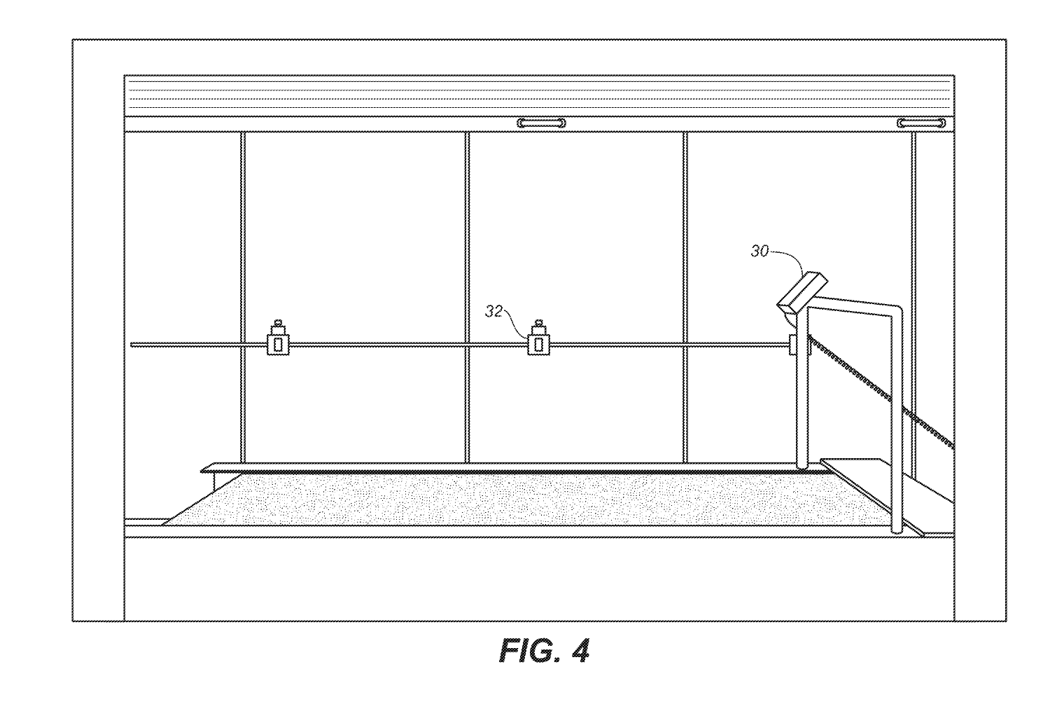

FIG. 4 is a side view of an animal training environment according to the invention. In embodiments of the invention, the enclosure has openings on the side, back, front, and top to provide flexibility in setting up training scenarios. For example, the side and/or top of the enclosure may be opened to present external distraction or stimulus to the animal.

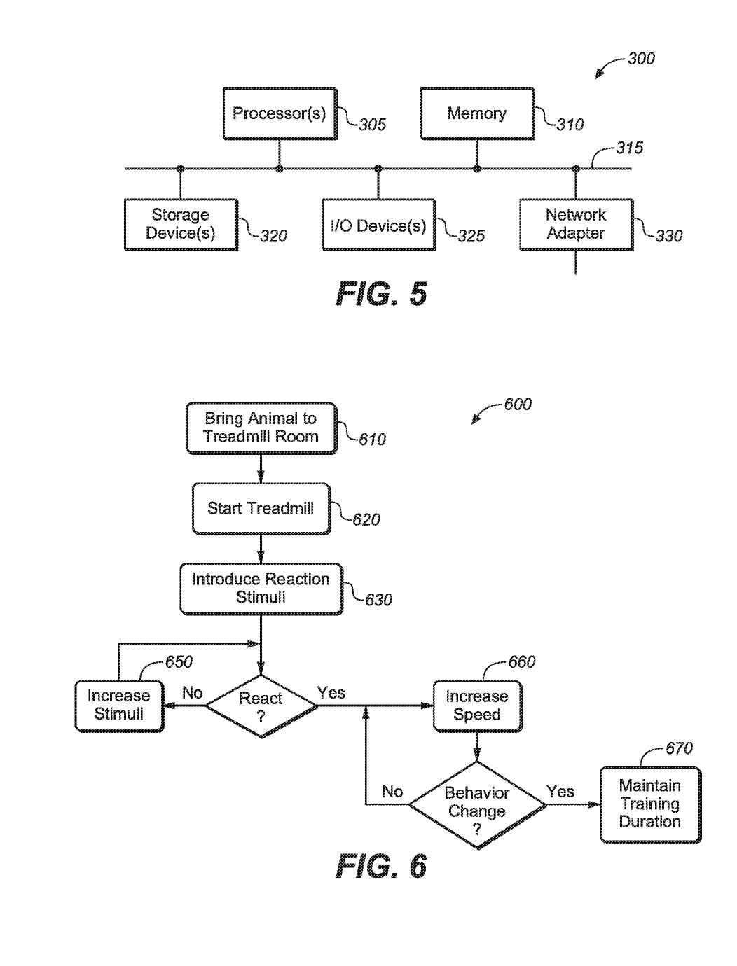

A computer system may be utilized. Embodiments of the invention realize coordination of treadmill operation and operation of the various environmental and virtual features through programmatic operation of one or more computers. FIG. 5 is a block diagram of a computer system as may be used to implement certain features of some of the embodiments. The computer system may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions (sequential or otherwise) that specify actions to be taken by that machine.

The computing system 300 may include one or more central processing units (“processors”) 305, memory 310, input/output devices 325, e.g. keyboard and pointing devices, touch devices, display devices, storage devices 320, e.g. disk drives, and network adapters 330, e.g. network interfaces, that are connected to an interconnect 315. The interconnect 315 is illustrated as an abstraction that represents any one or more separate physical buses, point to point connections, or both connected by appropriate bridges, adapters, or controllers. The interconnect 315, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called Firewire.

The memory 310 and storage devices 320 arc computer-readable storage media that may store instructions that implement at least portions of the various embodiments. In addition, the data structures and message structures may be stored or transmitted via a data transmission medium, e.g. a signal on a communications link. Various communications links may be used, e.g. the Internet, a local area network, a wide area network, or a point-to-point dial-up connection. Thus, computer readable media can include computer-readable storage media, e.g. non-transitory media, and computer-readable transmission media.

The instructions stored in memory 310 can be implemented as software and/or firmware to program the processor 305 to carry out actions described above. In some embodiments, such software or firmware may be initially provided to the processing system 300 by downloading it from a remote system through the computing system 300, e.g. via network adapter 330.

The various embodiments introduced herein can be implemented by, for example, programmable circuitry, e.g. one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

FIG. 6 is a flow chart 600 of a training/habituation session according to an embodiment of the present invention. Each step of the process may be varied in intensity, duration, and/or order depending on needs of any particular training/habituation session. The session begins, for example, at step 610 by introducing the animal, which may be a dog, cat, parrot or other animal that is to be trained or habituated [in some circumstances, humans may benefit from the programs] to the treadmill room. The treadmill room is, for example, a room fitted with a custom, essentially wall-to-wall (or oversized) treadmill that may include a runway on one or both sides suitable for use as a walkway for a trainer. The walkway may be utilized for the trainer's convenience and/or the introduction of various stimuli.

As with all the various embodiments and features of the present invention, the treadmill room may include one, all, or any combination of the various features noted above and elsewhere herein as will be understood by the ordinarily skilled artisan in light of the present disclosure. Similarly, the treadmill room may be absent any one or more of the various features including the room itself, as training may occur on a standard treadmill without a specifically built enclosure even though such an enclosure provides many advantages including that it is a generally more controlled and/or controllable environment.

At step 620 the treadmill is energized. Although the treadmill may start at any pace depending on the training regime, experience of the animal and/or trainer, etc., it has been found most effective to start the treadmill at a slow pace such as a moderate walking pace for the dog (references to dog apply also to other animals being trained), perhaps approximately 2-5 miles per hour, although another pace may be utilized. This relatively slower pace is effective to allow orientation to the treadmill, surroundings, and initial introduction of stimuli (step 620).

At the slower introductory pace, stimuli will generally produce a reaction in the dog. The reaction is expected and understood based on the dog's known behavior patterns. The reaction may be natural, e.g., a reaction to loud noise or other stimuli and/or a reaction occurring due to behavioral issue (not getting along, aggression, biting, excessive barking at another dog or human, as examples).

If the reaction does not occur, the stimuli may be increased (e.g., louder, more frequent, etc.) (step 650) and/or the stimuli may be changed or varied. Once the reaction (e.g., unwanted behavior) occurs the treadmill speed is increased to, for example a trot or fast trot or mere, while the stimuli continues to be applied. The stimuli may be continuously applied, or sit a. specified rate (e.g., one gunshot every 3 seconds or other time period). The specified rate may vary during the session (examples: a wide variation from single isolated shots to rapid fire, or, clanging noise(s) with relative silence in-between initiated at, for example, a varying rate from 2 times per second to once every 3-5 seconds, or other rates etc.). Note that the stimulus, one that normally elicits an unwanted reaction/behavior, occurs while the dog is working the treadmill at a speed that does not allow the dog to either act according to its known behavior issue or fully follow-through with the reaction (e.g., perhaps some initial muted reaction, but the dog, out of necessity, quickly gets back to working the treadmill.

While the preceding steps such as starting slowly on the treadmill and initiating the stimulus and faster treadmill speeds in step fashion is believed to be less stressful for the dog, the invention may be directly applied without any preliminary phase-in either of the treadmill or stimuli. That, is bringing the animal to the treadmill and ramping the speed up to a trot/run and immediately applying the stimuli is also effective in treating/habituating the animal to the stimuli such that it is less likely/will not react in the same negative or harmful way as before the training session.

Once the appropriate stimuli amount and treadmill speed are reached, the program should continue for the prescribed amount of time (step 670). The amount of time prescribed will depend on the dog and the severity of the behavior problem (e.g., how much of a problem the dog has). Training sessions should typically last approximately 15 or 20 minutes and a majority of that time should be maintaining training duration, step 670—although other lengths are also known to be beneficial.

The inventors have found that a single session can make a large improvement in the dogs so treated. However, more can be expected to be needed to fully habituate the animal. In one embodiment, the training sessions are repeated as necessary on a case-by-case basis until the dog is fully habituated. In other embodiments sessions are scheduled on a daily, every other day, 3× per week, or weekly basis. In general, [two weeks] of training can fully habituate the dog—a month in more difficult cases. Some dogs may never fully habituate, but the inventors experience is that all dogs exhibit positive behavior modification.

Further, many types of training can benefit from the invention in its various forms. For example, physical and reactivity rehabilitation, commands, exercise, and essentially any form of unwanted behavior and/or behavior modification.

Pre-programmed stimuli. Combined, pre-programed stimuli and treadmill speed. The program may include hill climbs (inclined treadmill), and the “terrain” may vary. Tilting the treadmill left and right and “rolling” treadmill may also be utilized. All such variations may be pre-programmed or ready for use by a trainer in an on-the-fly training session where the speed, orientation, and stimuli are manually initiated, changed, or stopped, by the trainer. A combination of pre-programmed routines and on-the-fly training sessions are also suitable. Pre-programmed routines may be as simple as varying the speed of the treadmill over a session (e.g., slow to fast).

Other more sophisticated pre-programmed routines may not only vary treadmill speed but also varying stimuli, but also coordinate the same such that a sudden increase in stimuli may be accompanied with an increase (e.g. temporary increase) in treadmill speed. Such pre-programmed stimuli and/or treadmill speed may be maintained, for example, in computer memory, as a computer program or computer script that functions to send signals to the treadmill and any stimuli generating devices (such as audio amplifiers, robotics, or other devices in the training room), Reactions to autos, children playing, etc. are good habituations for pets and particularly service dogs. Reactions to more threatening stimuli like people shouting, aggressive driving, gunshots, and bombs, are critically important for police and military dog training.

As noted above a surround sound system may be utilized. Other, even more sophisticated audio programs (e.g., Barco Aura, Dolby Atmos, others) may be utilized. Even ordinary or simpler training programs may benefit from the same, however, training regime for Police and/or military can, out of necessity, themselves can be quite sophisticated and have more benefit. Use of gunfire as replicated over an object based system allows the system designer to accurately place the trajectory of the gunfire from/to different locations in the training room. The gunfire itself may be timed to other actions including yelling, sounds of motorized vehicles, some of which may also be sounds played over the audio system or be actual devices in operation, live actors, etc. The gunfire may be pre-recorded, system generated, or a combination of “live” fire (e.g. blanks), and audio from system speakers.

For example, a “live” fire gun may discharge (using blanks) which is essentially an identical look and feel to the initial firing of a live round of ammo. Such discharges may be controlled remotely by a trainer or automatically by a controller (e.g., as part of computer programming). The sound system may be coordinated to bring spatialized sound, a second or fraction of second afterward, that makes it sound like a bullet whizzes right by or over and past the dog. The same type of coordination can emphasize and carry out many other types of sounds and situations encountered in training as in real life such as vehicles, enemy actions, diversions, bombs, etc.

“Live” fire+audio can be further coordinated with a visual system such as a computer monitor (large widescreen television, wrap around monitors, etc.) that display battlefield, Police situations, etc. The video itself may be coordinated pre-recorded (and played in sync with any “live” fire), or may be computer graphic oriented. In one embodiment games such as Battlefield, Black Ops, Black Hawk Down, etc. are utilized out of the box and/or modified to operate in the training environment.

The visual system is preferably a High Dynamic Range (HDR) system which enhances the contrast ratio and usually increases peak brightness (with all of these, higher capability is better) and which may be utilized to enhance high brightness high contrast events such as gunfire and/or explosions particularly in the evening/at night/morning. The training session may be operated at night and in darkness or during the day at any light level by enclosing the training room, and relying on very low levels of light from the displays for situational objects friend and foe. The light level itself may be programmed along with any audio and may include bright LED flashes, flash bulbs, etc. that originate from any location of the room and may even “travel” across the room (e.g., series or “string” of individually programmable LEDs).

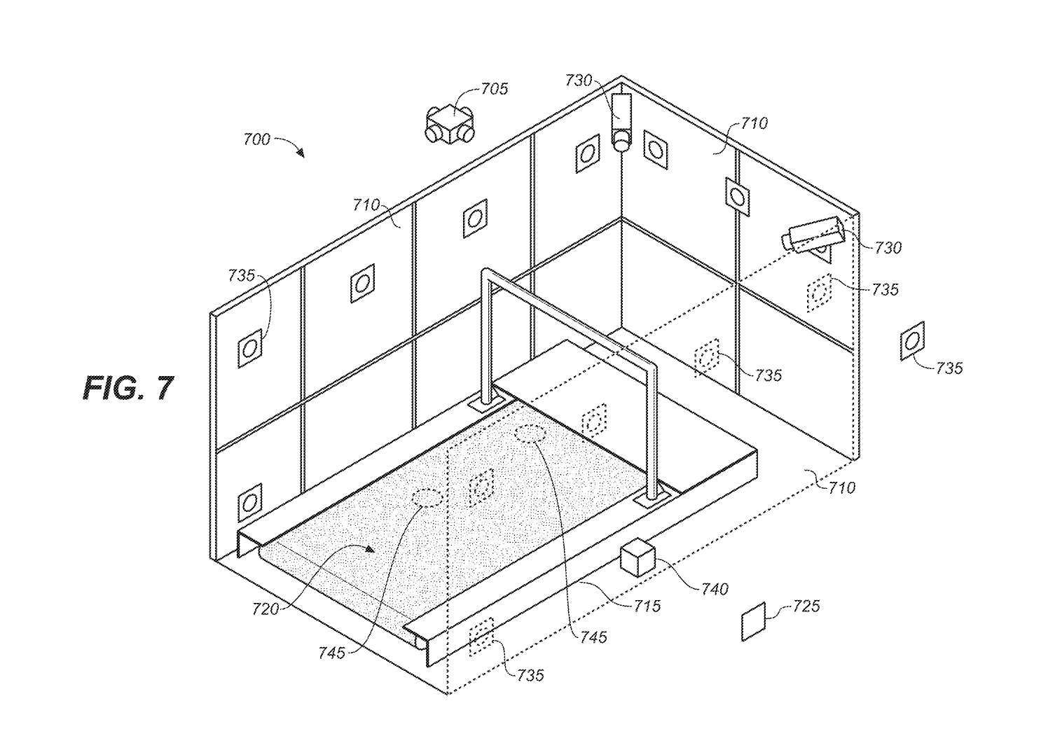

FIG. 7 is a sketch of a training box 700 that is a training environment according to various embodiments of the present invention. The box may be constructed, for example, from a shipping container or other like sized enclosure. The box includes an immersive video system that may be a projection system 705 that projects onto the interior walls 710 of the box or panel displays (such as LCD televisions) on one or more walls of the box. The immersive video is, for example a 360 degree video, but may be any variation such as front video only, or front and sides. In various embodiments, the immersive video includes projections onto a belt surface 720 of treadmill 715.

The projector and/or displays sire connected to, for example, a video server or a controller (e.g., computer) 725 that provides video (and/or graphics) to the projector/displays. The controller is configured, for example, to synchronize the video with other elements in the training environment such as the speed of the treadmill 720. For example, when the treadmill 720 is moving slow, the scenes displayed on the walls move by slowly, and then faster when the treadmill speeds up. The treadmill has a safety bar 725. In one embodiment, the safety bar 725 is adjustable in height and adjustable to various forward and back positions.

In addition to video, the controller may also include objects or other graphics on top of/along with video or other graphics. Such included object may be VR like subjects, bad guys, other stimuli, or may also be an output based on behavior of the dog in training. For example, if the dog successfully completes a task such as touching a predetermined “spot” on the treadmill belt (e.g., “spots” 745), a flash, a bell, or other reward stimulus may be triggered. Such award could be a preprogramed graphic of the dog trainer saying “Good job!” And may also include the dog's actual name and the trainer's voice, all of which may be maintained in a database on the server (or cloud storage accessible by the controller).

In one embodiment, the belt surface includes touch sensitive sensors connected to the controller which is then programmed to provide video or trigger other actions/events. The connection (or other connections necessary for communications in the training environment) may be wired, wireless) optical recognition (via camera(s) 730 for example), or other signaling means). Such other actions events may be anything from basic sounds and/or praise/awards, to gunfire simulations.

The touch sensitive areas may also be illuminated with special projections of objects or items related to the training. Such objects or items may be, for example, street signs, crosswalks, curbs, terrain, plumbing fixtures, or any other item or object that might be encountered in the environment to which the training is intended to simulate. The objects of items may be part of a pre-programmed sequence or random. The “touch sensitive” areas may be implemented without touch sensitivity and may be triggered by other means such as an optical recognition device (e.g., cameras and appropriate recognition software on server or in the cloud.) Such sensitivity/triggering is preferably coordinated with other actions/responses in the training environment. The coordination may be specific or random changes in video displayed on one or more screens or walls of the training environment or activation of robotic or other connected devices.

The belt surface itself may be of various materials of different characteristics/qualities to enhance safety or play a role in the training environment. Such materials may include, for example, felt, padded material, astro-turf, astro-turf with padding, rubberized astro-turf, etc. for animal pad safety/health and more realistic environments. Other non-traditional treadmill belt materials may also be utilized, and the surface may be customized or changed depending upon the training goals such that the belt and the training environment, make a closer match the actual environment in which the training is intended to be utilized.

The training environment may also be outfitted with cameras 730, which may be located in front providing views of the training environment. The cameras may be connected to the controller which may at the request of the trainer (or automatically) look up an owner's text/email and send a message with details to log on and watch the training session vis live streaming.

The cameras may also be connected to the controller and image recognition software to identify actions of the dog and/or trainer which are then used to direct further training regime, or control the training environment such as to stop, slow-down, or speed-up the treadmill. For example, crossed arms of the trainer may be an emergency signal to halt all motion devices including the treadmill, and a gun-like hand position/motion may signal the controller to activate a gun shot in the direction pointed (e.g., police/military training). In one embodiment, a tablet is connected to the controller and operates as at controller for the trainer. The tablet includes sound controls that, for example, direct the locations in the training environment where various sound comes out of (e.g., as indicated by the trainer via the tablet). The sound controls may take the form of an outline or image of the training environment that may be tapped by the trainer at the location where sounds are desired. The sounds may be selected via and form of selection mechanism, selection box, drop down menu, etc.

The training environment includes an immersive sound system to replicate the various training sounds and place them in appropriate locations relative to the dog being trained, trainer, other items in the training environment, etc. For example, the sound system may be programmed to put a skateboard sound behind the dog and/or trainer, approaching at typical skateboard speeds and then zip past the dog on the dog's right side. On the right side of the training environment, coordinated with the skateboard sound, a skateboard & boarder image moves from back to front and then onto the wall or screen at the front of the training environment and then out of sight. The image and sound appear quickly and are part of a pre-programmed or instructor-initiated sequence such that the instructor is ready to make corrections for any unwanted behavior of the dog. Instructor initiated sequences may be initiated, for example, via buttons, mobile device app, hand signals via optical recognition, or other mechanisms.

Speakers 735 are placed all around and are connected, to the controller which executes an immersive sound system such as Dolby Atmos. Speakers are also placed under the treadmill and are utilized for vibrational stimuli and/or feedback through the treadmill belt. In one embodiment, thin flat speakers are attached directly to the treadmill belt to provide spots on the treadmill having strong and direct vibrational feedback. In one embodiment, the speakers on the belts are also in conjunction with the aforementioned touch sensitivity and elicit direct and immediately activated feedback to the dog in the form of vibration (or sound/other feedback) when touched (e.g., touch turns the feedback on). Various training regimes may be implemented with such touch sensitivity and feedback.

The training environment may also include a workstation terminal for which the trainer may log in, select programs, and otherwise control the training environment. The workstation and training environment may be automatically set up via wireless identification of the dog (e.g., scanning a microchip implanted in the dog or it's collar). Such set-up may include notifying the owner of the training session about to begin. The training session may also be recorded and stored for review by the owner and/or consultation by the trainer or other reviewer. Any and all functions of the workstation may also be performed via the tablet and visa-versa. The training environment may include a tablet, or workstation or control buttons. In addition, all such functions may be performed, for example, via remote logon over the Internet, via mobile phone, etc.

The training environment may also include an odor/smell device 740 which, may also be connected to the controller and configured to inject smells into the air or scents onto the treadmill at predetermined times and/or in conjunction with certain events. An environment that includes a scent device that puts substances (e.g., scent drops) on the treadmill for smell/odor simulation or detection training may also include a cleaning device that may be located on the trailing end or underside of the treadmill to remove the scent when appropriate (e.g., after training, or during training to meet the needs of any particular training regime). Application and/or removal of scents may be performed via rollers, brushes, spray washers, etc. The scents may be utilized for tracking training or medical detection training such as detecting illnesses, cancer, etc.

The training environment may be utilized for remote training. In one embodiment, the training environment is installed, in a snipping container and loaded onto a truck or trailer that is parked near a training client's residence or place of business. The training client is a dog owner and the client and his/her dog enter the training environment and the trainer logs in remotely to direct a training session with the dog and client/owner. In one embodiment, the dog is automatically scanned upon entering the training environment which then initiates the session with the/an appropriate trainer. In addition to shipping via trailer or truck, if the training environment is constructed sturdy enough, such as the embodiments where it is constructed in a steel shipping container, axles, wheels, and a hitch may be attached directly thereto and towed to any desired accessible location.

The present invention includes a method of providing a portable training environment, which a training environment in a shipping container is well suited. A trainer may be present or remotely connected via cell phone 4G, 5G, WiFi, satellite or other connections. The method may be implemented by towing or otherwise transporting the portable training environment to a fair, trade show, pet store parking lot, hospital, etc. Appointments may be made in advance via an online booking & payment system, and the doors can automatically unlock or open when a customer reaches the portable training environment. A discount coupon for a pet store or nearby attraction can be transmitted to training environment patrons before or after the session. Purchases via the coupon can be tracked. The training session may be at least partially monetized by commissions or other payment by the store based on additional customers purchases in lieu of or in addition to any training fees.

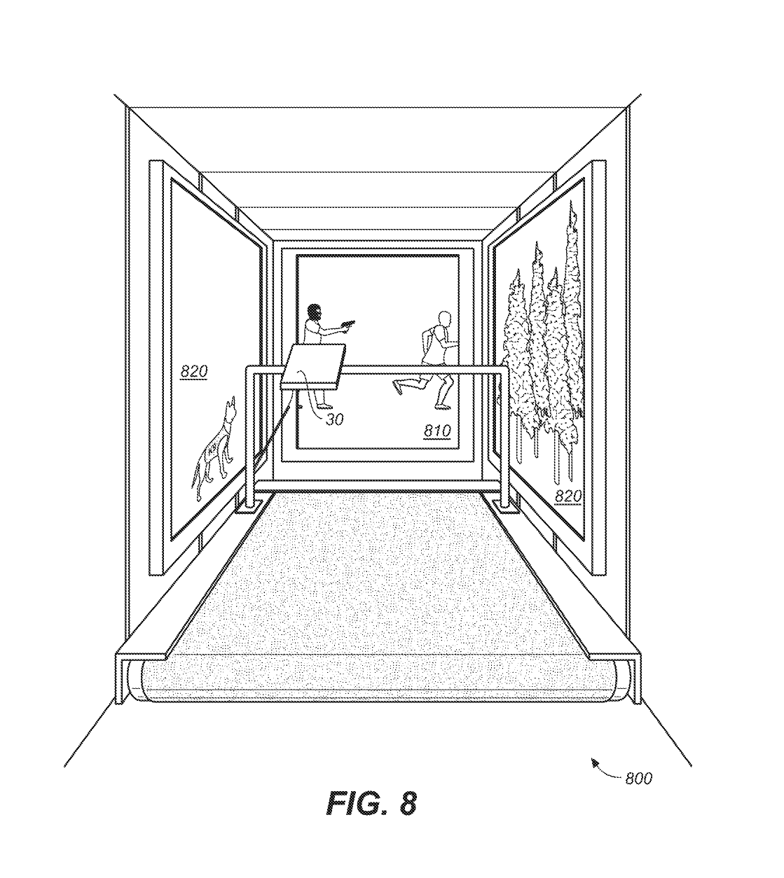

FIG. 8 is a sketch of an embodiment of the present invention illustrating a training environment 800 with simulator like all-sides video. Some items previously discussed or illustrated and necessary or helpful in the training environment 800 have been omitted for clarity. In FIG. 8, the training environment 800 includes a front screen 810 for displaying video that portrays actions, events, and/or settings of the training environment. Side screens 820 display left and right scenes preferably related to the front screen. The screens/displays are situated close together to provide an essentially seamless environment. The front and side screens may be provided by a continuously flexible wrap around display such that such that there is no seam between front and side scenes. The video may be projected to the screens, or the screens themselves may be a display such as LCD, OLED, plasma, or other display technologies. Preferably such projections or displays are high resolution (HD, 4k, 8k, etc.) and of high dynamic range.

FIG. 8 illustrates a military/police training scenario, but many other training scenarios are to be utilized, such as: street scenes emphasizing either cars and/or pedestrians; indoor scenes such as door bells, door knocking, mail/package delivery ringing, etc., and others including scenarios addressing or helpful for any of the behaviors listed and/or discussed elsewhere herein. Furthermore, environments and stimuli that cause unwanted behavior in situations/scenarios not discussed herein can be similarly crafted to address the unwanted behavior.

The portion of the training environment provided by the screens/displays can be either simply part of the environment in which stimuli is introduced or the screens/displays can themselves introduce the stimuli. This is most useful for cases where the animal is being habituated to the stimuli. However, the various training scenarios, including that illustrated in FIG. 8, are useful both in habitation cases and for regular training (e.g., familiarizing/bonding a dog with his/her handler in a controlled realistic environment). In addition, such scenarios may include recorded (or live action) video from remote locations and/or actual police, military, or other operations displayed on the screens.

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing “live” fire training many other devices may be utilized to cause a similar stimuli such as a firecrakers, pop caps, recordings, banging drums or scrap metal sheets, garbage cans/lids, or any other device having a similar or equivalent function or capability, whether or not listed herein, may be substituted therewith.

Furthermore, the inventors recognize that newly developed technologies not now known may also be substituted for the described parts and still not depart from the scope of the present invention. All other described items, including, but not limited to treadmills, treadmill designs, shipping containers, and the overall training environment which may include AR, VR, vehicles, robotics, animatronics, automatronics, video and sound systems, enclosures, etc., should also be considered in light of any and all available equivalents, substitutes, and reasonable derivations.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, HD-DVD, Blue-ray, CD-ROMS, CD or DVD RW+/−, micro-drive, and magneto-optical disks, ROMs, RAMs, EPROMs, EEPROMs, DRAMs, VPAMs, flash memory devices (including flash cards, memory sticks), magnetic or optical cards, SIM cards, MEMS, nanosystems, RAID devices, remote data storage/archive/warehousing such as cloud storage, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, playing sounds at pre-determined and/or random sequences, coordinating sounds with video or other “live” devices in the training environment, control (on/off, volume adjustment, speed up/slow down sequence and/or treadmill speed), cues to trainers, etc. The training environment may include, for example, a workstation or display screen that shows cues to keep a trainer on track or advised of upcoming program events and may also direct the trainer to take certain actions in time with events in the sequence. The display screen may also include at set of intuitive buttons or other controls to adjust any or all adjustable features of the training sequence environment.

Carious embodiments of the invention include a training system and/or a training environment comprising a treadmill and at least one stimuli, which may be a stimuli introduction device. An embodiment of the invention may also be described as placing a dog on a treadmill and training the dog for something other than being on a treadmill.

The treadmill may comprise a treadmill having a wall-to-wall track and may be installed, in a portable room, such as a shipping container. In other embodiments, the treadmill track is a triple wide. The treadmill dimension may closely match the room in which it is installed.

The training environment may include a sound system configured to produce spatialized dog training stimuli and may be further configured to produce the spatialized sound in coordination with related non-sound system based stimuli (or actions of the dog and/or trainer including specific training environment commands by the trainer).

The present invention includes a training method of placing a dog on a treadmill at a speed that hinders or prevents the animal's reaction to a stimulus, and introducing the stimuli while the dog is “moving” on the treadmill. The stimuli may be, for example, a human action, sudden noise, gunfire, another animal, or a virtual event. The stimuli may comprise a live action event enhanced by one of an audio or visual electronic system. The method may include the step of continuing to introduce (and/or changing) the stimuli over time while the dog is running (or walking). The treadmill speed may be increased, maintained, and/or varied during the training session. Speed variations may be coordinated with stimuli or other events of a training program. Such speeds may include “moving” on the treadmill at one of a trot, run, and gallop, varying between a trot, and a run, or any other speeds and/or variations.

The present invention includes a mobile training method, comprising the steps of configuring a mobile training environment including treadmill, placing the mobile training environment at a customer location, and implementing a training regime that includes placing an animal on the treadmill and training the dog for something other than being on the treadmill.

The present invention may suitably comprise, consist of, or consist essentially of, any of element (the various parts or features of the invention and their equivalents as described herein. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

What is claimed is:

1. A training system, comprising:
a treadmill; and
a stimuli introduction device.

2. The training system according to claim 1, wherein the treadmill comprises a treadmill having a wall-to-wall track.

3. The training system according to claim 2, wherein the training system is installed in a portable room.

4. The training system according to claim 1, wherein the treadmill comprises a wider than standard track essentially fitting wall-to-wall in a portable room.

5. The training system according to claim 3 wherein the portable room comprises a shipping container or having shipping container-like dimensions.

6. A training system according to claim 4, further comprising a sound system configured to produce spatialized dog training stimuli.

7. The training system according to claim 6, wherein the sound system is configured to produce the spatialized sound in coordination with related non-sound system based stimuli.

8. The training system according to claim 7, wherein the non-sound system based stimuli comprises a training aid device located in the portable room.

9. A method, comprising the step of:
placing a dog on a treadmill at a speed that hinders or prevents the animal's reaction to a stimulus; and
introducing the stimuli while the dog is “moving” on the treadmill.

10. The method according to claim 9, wherein the stimuli comprises one of a human action, sudden noise, another animal.

11. The method according to claim 9, wherein the stimuli comprises a gun firing.

12. The method according to claim 9, wherein the stimuli comprises a live action event enhanced by one of an audio or visual electronic system.

13. The method according to claim 9, farther comprising the step of continuing to introduce the stimuli over time while the dog is running.

14. The method according to claim 13, further comprising the step of changing the stimuli over time.

15. The method according to claim 13, further comprising the step of increasing speed on the treadmill until at behavior change relative to the stimuli is noted.

16. The method according to claim 15, further comprising the step of maintaining the increased speed for a duration of the method.

17. The method according to claim 15, further comprising the step of maintaining the treadmill speed at approximately the increased speed with, variations coordinated with stimuli or other events of a training program for a duration of the method.

18. The method according to claim 9, wherein the dog is “moving” on the treadmill at one of a trot, run, and gallop.

19. A mobile training method, comprising the steps of:
configuring a mobile training environment including treadmill,
placing the mobile training environment at a customer location, and
implementing a training regime that includes placing an animal on the treadmill and training the dog to modify behavior from introduced stimuli.
